(19) United States
(12) Patent Application Publication
(10) Pub. No.: US 2006/0289189 A1
(43) Pub. Date: Dec. 28, 2006

(54) Resin-coated micron conductive fiber wiring

(76) Inventor: Thomas Aisenbrey, Littleton, CO (US)

Correspondence Address: DOUGLAS R. SCHNABEL, 1531 WEDGEWOOD PLACE,, ESSEXVILLE, MI, 48732, US

(21) Appl. No.: 11/447,774

(22) Filed: Jun. 5, 2006

Related U.S. Application Data
(60) Provisional application No. 60/687,613, filed on Jun. 3, 2005.

(51) Int. Cl. H01B 11/06

(52) U.S. Cl. 174/36

(57) ABSTRACT

A resin-coated, micron conductive fiber wiring material, a method of fabricating, and applications are achieved. The micron conductive fibers may be metal fiber or metal plated fiber. Further, the metal plated fiber may be formed by plating metal onto a metal fiber or by plating metal onto a non-metal fiber. Any platable fiber may be used as the core for a non-metal fiber. Superconductor metals may also be used as micron conductive fibers and/or as metal plating onto fibers in the present invention.

### RELATED PATENT APPLICATIONS

This Patent Application claims priority to the U.S. Provisional Patent Application 60/687,613, filed on Jun. 3, 2005, which is herein incorporated by reference in its entirety.

### BACKGROUND OF THE INVENTION

(1) Field of the Invention

This invention relates to resin-coated, micron conductive fiber wiring including methods of manufacture and applications.

(2) Description of the Prior Art

From common kitchen appliances to sophisticated temperature control devices for scientific application, resistive heating elements are ubiquitous in application. Most heating elements are highly resistive metal wire, such as nickel-chromium (nichrome) or tungsten, designed to provide the necessary resistance for the heating required. The resistance of the heating element is determined by the resistivity of the wire, its cross-sectional area, and its length. The heat generated by the heating element is determined by the current passing through the heating element. Typically, the heating element further comprises an outer layer of a material that serves as an electrical insulator and a thermal conductor.

Heat generated in a resistive heating element is transferred to heated objects by conduction, convection and/or radiation. Conduction heat transfer relies on direct contact between the heating element and the heated object. For example, the transfer of heat from an electric range to a metal pan is essentially by conduction. Convection heat transfer relies on fluid flow to transfer heat. For example, an egg cooking a pan of boiling water relies on convection currents to transfer heat from the metal pan through the water and to the egg. Water at the bottom of the pan is superheated causing it to lose density such that it rises. This rising superheated water-transfers heat energy to the egg floating in the water. Conversely, the water at the top of the pan is cooler and denser and, therefore, falls to toward the bottom of the pan. A convection current is thereby established in the pan of water. Radiation heat transfer relies on electromagnetic energy (such as light) to transfer heat from the heating element to the object. For example, a cake baking in an electric oven will be heated, in part, by the radiated heat from the glowing heating element. Radiant heating in how the sun's energy reaches the earth. In practical application, the three means of thermal transfer are found to interact and frequently occur at the same time.

Resistive heating elements used in various heating systems and applications have advantages over, for example, combustion-based heating sources. Electric heating elements do not generate noxious or asphyxiating fumes. Electric heating elements may be precisely controlled by electrical signals and, further, by digital circuits. Electrical heating elements can be formed into many shapes. Very focused heating can be created with minimal heat exposure for nearby objects. Heating can be performed in the absence of oxygen. Fluids, even combustible fluids, can be heated by properly designed resistive heating elements.

However, resistive heating elements currently used in the art have disadvantages. Metal-based elements, and particularly nichrome and tungsten, can be brittle and therefore not suitable for applications requiring a flexible heating element. Further, the large thermal cycles inherent in many product applications and the brittleness of these materials will cause thermal fatigue. Other metal elements, such as copper-based elements, bring greater flexibility. However, if the application requires the resistive element to change or flex positions, then the resistive element will tend to wear out due to metal fatigue. Metal-based resistive heating elements are typically formed as metal wires. These elements are expensive, can require very high temperature processing, and are limited in shape. In addition, when a breakage occurs, typically due to fatigue as described above, then the entire element stops working and must be replaced.

Several prior art inventions relate to resin-coated, micron conductive fiber wiring. U.S. Patent Publication US 2002/0090210 A1 to Grant et al teaches an internal heating element for pipes and tubes that utilizes a polymeric coated resistance heating wire. U.S. Patent Publication US 2004/0169028 A1 to Hadzizukic et al teaches a heated handle and a method of manufacture and more specifically teaches a heated steering wheel for an automobile. U.S. Patent Publication US 2001/0042632 A1 to Manov et al teaches a filter for wire and cable that utilizes at least one pair of inner conductive wires made of an electrically conductive metal covered with an outer layer of magnetic absorbing material. The outer layer is formed from glass-coated micro wires containing soft ferromagnetic amorphous material. U.S. Patent Publication US 2004/0187977 A1 to Matsui et al teaches ultra-fine copper alloy wire, stranded copper alloy wire conductor, extra-fine coaxial cable, and a process for producing ultra-fine copper alloy wires. U.S. Patent Publication US 2004/0118583 A1 to Tonucci et al teaches a high voltage, high temperature wire that utilizes a metal micro-wire and an inorganic cladding; where the outer diameter of the micro-wire is less than the inner diameter of the of the cladding.

### SUMMARY OF THE INVENTION

A principal object of the present invention is to provide a low cost and highly effective conductive material.

This objective is achieved by fabricating a resin-coated, micron conductive fiber wiring and by applying this conductive material to heating elements, conductors, and antennas or any other use within the EMF and/or thermal spectrum.

### BRIEF DESCRIPTION OF THE DRAWINGS

In the accompanying drawings forming a material part of this description, there is shown:

FIG. 1 illustrates an embodiment of the present invention showing a method to manufacture resin-coated, micron conductive fiber wiring.

FIGS. 2 and 3 illustrate embodiments of the present invention showing a section of resin-coated, micron conductive fiber wiring.

FIG. 4 illustrates an embodiment of the present invention showing an extruder head for use in manufacturing resin-coated, micron conductive fiber wiring.

FIG. 5 illustrates an embodiment of the present invention is illustrated showing an extrusion machine, or extruder.

FIG. 6 illustrates an embodiment of the present invention showing a heating element comprising the resin-coated, micron conductive fiber wiring.

FIG. 7 illustrates an embodiment of the present invention showing a stove-top heating element comprising the resin-coated, micron conductive fiber wiring.

FIG. 8 illustrates an embodiment of the present invention showing a medical cauterizing device comprising the resin-coated, micron conductive fiber wiring.

FIG. 9 illustrates an embodiment of the present invention showing audio wiring comprising the resin-coated, micron conductive fiber wiring.

FIG. 10 illustrates an embodiment of the present invention showing an antenna comprising the resin-coated, micron conductive fiber wiring.

FIG. 11 illustrates an embodiment of the present invention showing high power lines comprising the resin-coated, micron conductive fiber wiring.

FIG. 12 illustrates an embodiment of the present invention showing a resin-coated, micron conductive fiber wiring where multiple bundles of fiber are encased in the same resin coating.

FIG. 13 illustrates an embodiment of the present invention showing a resin-coated, micron conductive fiber wiring having fiber bundles wrapped around a center core.

FIG. 14 illustrates an embodiment of the present invention showing a resin-coated, micron conductive fiber wiring where a twisted pair of said wires is formed.

FIG. 15 illustrates an embodiment of the present invention showing a resin-coated, micron conductive fiber wiring with a single strand of fiber.

FIG. 16 illustrates an embodiment of the present invention showing multiple additional cross-sections for the resin-coated, micron conductive fiber wiring.

### DESCRIPTION OF THE PREFERRED EMBODIMENTS

This invention relates to resin-coated, micron conductive fiber wiring, methods of manufacture, and applications.

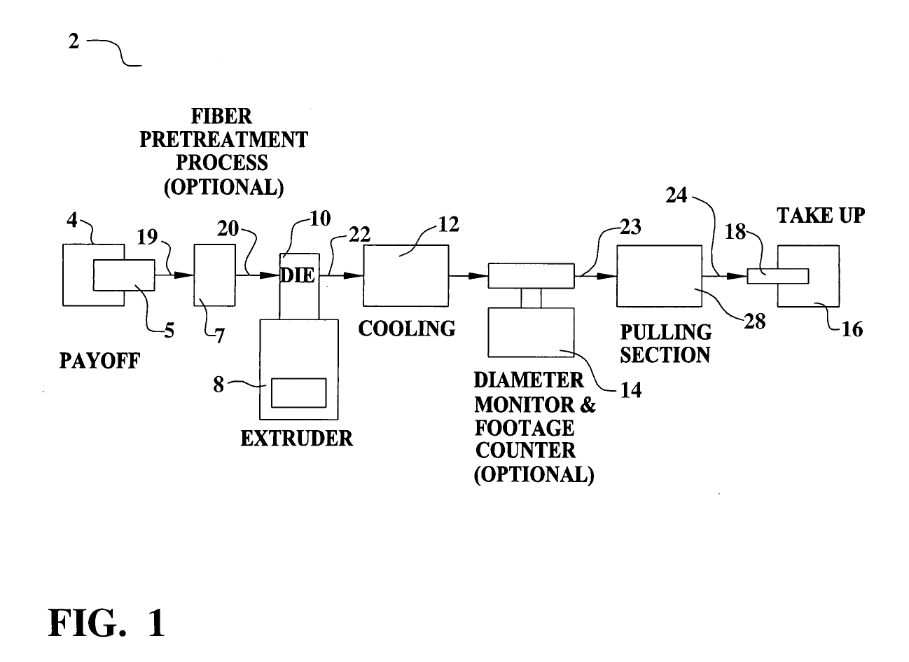

Referring now to FIG. 1, an embodiment of the present invention is illustrated. A schematic 2 shows a manufacturing flow for forming the resin-coated, micron conductive fiber wiring of the present invention. In this method, an extrusion/pultrusion process is used to extrude the resin-based coating onto the bundle of micron conductive fiber strands. In the illustrated embodiment, a reel 5 of bundled micron conductive fiber 19 is loaded onto a payoff apparatus 4. The micron conductive fiber 19 preferably comprises multiple, parallel strands of micron conductive fiber. The bundle 19 preferably comprises up to tens of thousands of strands of fiber.

The micron conductive fiber bundle 19 is routed into the extrusion die 10. In some embodiments of the process, however, it is useful to pre-process the fiber bundle 19 prior to extrusion. A pretreatment process 7, or combination of processes, is performed to enhance the characteristics of the fiber bundle 19 prior to extrusion. Pretreatment processes include, but are not limited, leeching processes that add materials to the bundle and chemical modification processes that improve the fibers interfacial properties.

In one embodiment of a leeching pretreatment process 7, the micron conductive fiber 19 from the payoff reel 5 is first routed into a powdering apparatus 7 prior to routing into the extrusion apparatus 8 and 10. The powdering apparatus 7 preferably comprises a solution comprising micron conductive powder suspended in a liquid media. As the fiber bundle 19 is fed through the liquid media, the micron conductive powder in the solution leeches into the micron conductive fiber 19. The resulting treated fiber bundle 20 is thereby impregnated with micron conductive powder.

There are several embodiments of inert chemical modification processes that improve the fibers interfacial properties. Treatments include, but are not limited to, chemically inert coupling agents, gas plasma, anodizing, mercerization, peroxide treatment, benzoylation, and other chemical or polymer treatments. A chemically inert coupling agent is a material that is bonded onto the surface of metal fiber to provide an excellent coupling surface for later bonding with the resin-based material. This chemically inert coupling agent does not react with the resin-based material. An exemplary chemically inert coupling agent is silane. In a silane treatment, silicon-based molecules from the silane molecularly bond to the surface of metal fibers to form a silicon layer. The silicon layer bonds well with the subsequently extruded resin-based material yet is chemically inert with respect to resin-based materials. As an optional feature during a silane treatment, oxane bonds with any water molecules on the fiber surface to thereby eliminate water from the fiber strands. Silane, amino, and silane-amino are three exemplary pre-extrusion treatments for forming chemically inert coupling agents on the fiber.

In a gas plasma treatment, the surfaces of the metal fibers are etched at atomic depths to re-engineer the surface. Cold temperature gas plasma sources, such as oxygen and ammonia, are useful for performing a surface etch prior to extrusion. In one embodiment of the present invention, gas plasma treatment is first performed to etch the surfaces of the fiber strands. A silane bath coating is then performed to form a chemically inert silicon-based film onto the fiber strands. In another embodiment, metal fiber is anodized to form a metal oxide over the fiber. The fiber modification processes described herein are useful for improving interfacial adhesion and/or reducing and preventing oxide growth (when compared to non-treated fiber). Pretreatment fiber modification may also reduce levels of dust, fines, and fiber release during subsequent cutting or vacuum feeding. After the optional pretreatment, the treated micron fiber bundle 20 is routed into the extruder die 10.

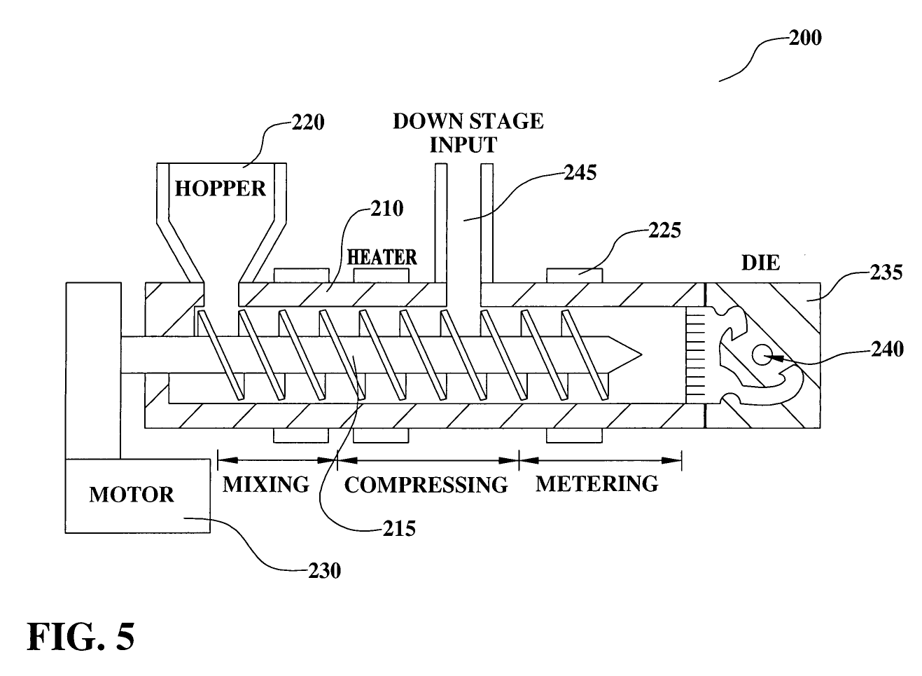

The extruder 8 and 10 is used to form resin-based material onto the fiber bundle 20. Several important features of the extruder 8 and 10 are described herein. Referring now to FIG. 5, an embodiment of the present invention is illustrated showing an extrusion machine, or extruder. The extruder comprises a hopper unit 220. Resin-based molding material is loaded into the hopper unit 220. In one preferred embodiment, the resin-based molding material comprises pure resin-based material in the form of pellets, sheets, rods, or lumps. In other preferred embodiments, various additives, lubricants, colorants, plasticizers, and other materials typical to the art of plastic molding are added to the resin-based material in the hopper 220. In yet other preferred embodiments, micron conductive powders and/or fibers are added to the resin-based material in the hopper 220. In other preferred embodiments, a pre-compounded resin-based material, where the resin-based material is pre-mixed with a combination of additives, lubricants, colorants, plasticizers, conductive powders and fibers, is loaded into the hopper 220. In another preferred embodiment of the present invention, the resin-based hopper load is constantly fed at a rate to sustain high-volume extrusion of resin-based material onto the continuous fiber bundle 20. Any of a number of known material conveyances may be used, such as gravity feeders, vibratory feeders, and the like.

The hopper 220 feeds the resin-based material into a barrel 210 and screw 215 mechanism. The screw 315 is essentially a large auger that fits closely inside of the barrel 210. A motor 230 turns the screw 315 inside the barrel chamber 210 to create a combination material feeding, heating, and mixing effect. The barrel 210 is heated by this turning friction and by heaters 225 that are distributed around the barrel 210. The screw 215 and barrel 210 mechanism conveys the resin-based material away from the hopper 220 and toward the mold 235. In the mixing section of the screw 215 and barrel 210, the primarily actions are mixing and heating of the resin-based material. Melting begins to occur but without compression. In the subsequent compression section, the resin-based material is completely melted. Compression of the molten blend begins. In the subsequent metering section, the final mixing and homogenization of the resin-based material and all additives, lubricants, colorants, plasticizers, conductive fillers, and the like, is completed to generate physically homogenized material. The resin-based material is then forced through a crosshead die 235. In the crosshead die 335, the resin-based material converges on the micron fiber bundle 20. The micron conductive fiber bundle 20 is routed through the hollow core or ring 240 of the die 235 such that molten resin-based material surrounds the bundle and is extruded onto the bundle as the bundle passes through. An optional down stage input 245 is shown on the extruder barrel 210. This additional material input is useful for adding components to the resin-based material after the main mixing and compressing sections of the barrel 210.

In another preferred embodiment of the present invention, a twin screw extruder is used. A twin-screw extruder has two screws that are arranged side-by-side and rotate in an intermeshing pattern that typically looks like a “FIGURE 8” in end view. The intermeshing action of the two screws constantly self-wipes the screw flights or inner barrel surfaces. A single screw extruder may exhibit difficulty with resin-based material adhering to the barrel sidewalls or flaking. However, a twin-screw extruder forces the resin-based material to follow the figure eight pattern and thereby generates a positive pumping action for all forms of resin-based material. As a result, a twin screw extruder is typically capable of operating at faster extrusion rates than a single screw extruder.

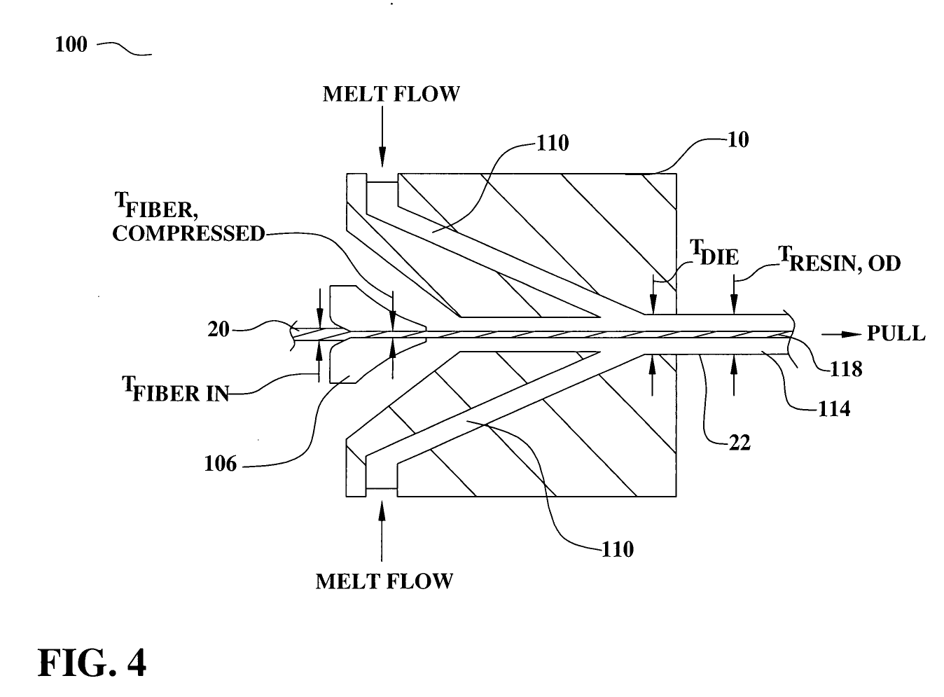

Referring now to FIG. 4, a preferred embodiment of a crosshead die 10 of the present invention is illustrated in cross-sectional view. Several important features of the crosshead die and the method of extruding should be noted. An opening is made through the die 10 to allow the micron fiber bundle 20 to pass through. The bundle 20 passes routing channels containing the melted resin-based material 110.

The incoming fiber bundle 20 has a relatively thick diameter T_{FIBERIN}. Although each fiber strand is aligned in parallel, there are air gaps between the strands. Prior to entering the crosshead die 10, the bundle 20 passes through a compression ring 106. The compression ring 106 progressively forces the fiber strands together and puts a compression force on the collective bundle. As a result, the outer diameter is reduced to T_{FIBER,COMPRESSED} as the compressed bundle 118 exits the compression ring 106.

By incorporating the novel step of compressing the fiber bundle 20, prior to extrusion coating with the molten resin-based material, several advantages are derived. First, the compression introduces an initial force onto the compressed bundle 118. After the resin-based material coats onto the compressed bundle 118, the fiber strands mechanically rebound against the resin-based material 114. This compression rebounding effectively locks together the fiber bundle 118 and the resin-based coating 114 in to what is herein called an extruded bundle 22. The compression/rebound effect is particularly important where a fiber material is selected that does not chemically bond well with the selected resin-based material. Second, during subsequent cutting of the extruded bundle, the compressed fiber 118 will be well-retained, or locked, in the resin-based outer covering 114. The fiber is also locked into the resin-based material during subsequent handling of the resin-coated, micron fiber wiring. This fiber retention mechanism is accomplished without coating the fiber bundle with a different resin-based material prior to extrusion. Therefore, additional processing expense is avoided and, more importantly, adverse interactions of dissimilar resin-based materials, as described in the prior art, are avoided.

A controlled diameter of resin-based material 114 is extruded onto the compressed bundle 118. The resulting extruded cable diameter T_{RESIN,OD} is determined by the diameter of the die opening T_{DIE}. By controlling the extruded cable diameter T_{RESIN,OD,} a specified amount of resin-based material 114 is extruded onto the compressed bundle 118. As a result, the percent, by weight, of the micron conductive fiber 118 in the resulting extruded cable 22 is carefully controlled. In another preferred embodiment of the present invention, the conductive doping is determined by volume percentage.

The novel extrusion/pultrusion process produces a continuous extruded bundle 22 comprising a micron fiber bundle 118 with a resin-based material 114 extruded thereon. In one embodiment, the micron fiber bundle 118 further comprises embedded micron conductive powder that is leeched into the bundle 118 prior to extrusion. In another embodiment, the micron fiber bundle 118 further comprises a chemically inert coupling agent to aid in bonding between fiber and resin-based material. In another embodiment, the micron fiber bundle has been anodized to prevent further oxidation effects on the fiber surface. In another embodiment, the micron fiber bundle has been etched to improve surface adhesion between fiber and resin-material. In another embodiment, the resin-based material further comprises conductive doping, such as micron conductive fiber or powder, such that the extruded bundle carries conductive doping both in the core bundle 118 and in the extruded covering 114.

Referring again to FIG. 1, the extruded bundle 22 passes through a cooling process 12. The cooling process 12 reduces the temperature of the extruded bundle 22 by spraying with or immersing the bundle 22 in fluid such as water. The cooled extruded bundle 23 is pulled along by a pulling section 28. Preferably, the process 2 operates as a high-speed pulled-extrusion/pultrusion method similar to that used in the manufacture of conductive wiring. By pulling the cooled extruded bundle 23, the entire length of the micron conductive bundle is placed under tension. This tension allows the overall process to operate at high speeds without kinking or binding. The continuous resin-coated, micron conductive fiber wiring 24 is wound onto a take up reel 18 via a take up apparatus 16.

The above described co-extrusion process produces a continuous wire-like cable 24 comprising the conductive fiber bundle 118 surrounded by the resin-based material 114. Any shape of bundle and/or coating may be used. Preferably, both the bundle and the coating have substantially round cross sections. However, any variety of bundle and/or coating cross sectional shapes, such as rectangular, diamond, elliptical, star, and the like, may be used depending on the shape of the compression ring 106 and on the shape of opening of the extrusion die 10.

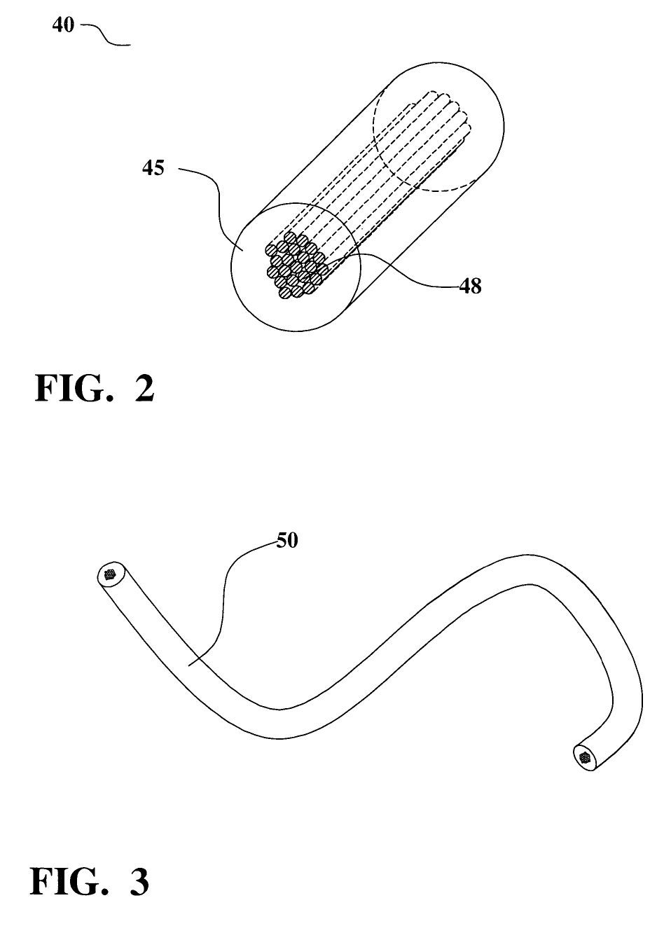

Referring now to FIGS. 2 and 3, embodiments 40 and 50 of the present invention is illustrated. A novel, resin-coated, micron conductive fiber wiring 40 is shown. In FIG. 1, a small section of the wiring 40 is shown. In FIG. 2, a longer section of the resin-coated, micron conductive fiber wiring 50 is shown. Referring again to FIG. 1, the resin-coated, micron conductive fiber wiring 40 comprises a bundle of micron conductive fiber strands 48 surrounded by a resin-based coating 45. The micron conductive fiber 48 may be metal fiber or metal plated fiber. Further, the metal plated fiber 48 may be formed by plating metal onto a metal fiber or by plating metal onto a non-metal fiber.

As important features of the present invention, the micron conductive fiber 48 comprises multiple strands of very fine fibers. In one embodiment, each fiber has a diameter of less than about 20 microns. In another embodiment, each fiber has a diameter of less than about 12 microns. The fibers comprise a metal, layers of metals, or metal alloys. Alternatively, the fibers comprise a non-metallic material having a metal or metal alloy plating such that a micron conductive fiber is achieved. Multiple strands of the micron conductive fiber are combined to form the bundle 48 as shown in FIG. 1. In one embodiment, the bundle comprises between about 1 strand and about 20,000 strands of fiber. The fibers may be twisted or non-twisted in the bundle 48. A wide range of wire gauges can be formed from the resin-coated, micron conductive fiber wiring depending on the diameter of the strands and the number of strands in each bundle.

As important features of the present invention, exemplary metal fibers 48 include, but are not limited to, stainless steel fiber, copper fiber, nickel fiber, silver fiber, aluminum fiber, nichrome fiber, or the like, or combinations thereof. Exemplary metal plating materials that are applied metal or non-metal fiber cores include, but are not limited to, copper, nickel, cobalt, silver, gold, palladium, platinum, ruthenium, rhodium, and nichrome, and alloys of thereof. Any platable fiber may be used as the core for a non-metal fiber. Exemplary non-metal fiber cores include, but are not limited to, carbon, graphite, polyester, basalt, melamine, glass, man-made and naturally-occurring materials, and the like. In addition, superconductor metals, such as titanium, nickel, niobium, and zirconium, and alloys of titanium, nickel, niobium, and zirconium may also be used as micron conductive fibers and/or as metal plating onto fiber cores in the present invention.

The resin-based coating 45 is a material such as any polymer resin or combination of compatible polymer resins. Non-conductive resins or inherently conductive resins may be used as the structural material. Conjugated polymer resins, one example being polythiophene, may be used as the structural material. Complex polymer resins, examples being polyimide and polyamide, may be used as the structural material. Inherently conductive resins may be used as the structural material. The dielectric properties of the resin-based material will have a direct effect upon the final electrical performance of the conductively doped resin-based material. Many different dielectric properties are possible depending on the chemical makeup and/or arrangement, such as linking, cross-linking or the like, of the polymer, co-polymer, monomer, ter-polymer, or homo-polymer material. Structural material can be, here given as examples and not as an exhaustive list, polymer resins produced by GE PLASTICS, Pittsfield, Mass., a range of other plastics produced by GE PLASTICS, Pittsfield, Mass., a range of other plastics produced by other manufacturers, silicones produced by GE SILICONES, Waterford, N.Y., or other flexible resin-based rubber compounds produced by other manufacturers. The resin-based coating may be selected to obtain the desired thermal characteristics such as very high melting point or specific thermal conductivity.

As another important feature of the present invention, the resin-based coating has a thickness range of between about 5 microns and about 10 millimeters. The resin-coating provides structural support and strength for the wiring 10. The micron conductive fiber 18 is very thin. Therefore, this material tends to break relatively easy. However, the presence of the resin-based coating protects the fiber bundle from breakage and provides an electrical insulation. In one embodiment, a Kevlar™ coating is used to provide substantial strength to the resin-coated coated, micron conductive fiber wiring. The thickness of the resin-based coating can be varied to achieve the ideal qualities of strength, thermal transfer, and size. In one embodiment, the coating is made very thin to speed heat transfer from the micron conductive fiber. In another embodiment, the coating is made very thick to slow heat transfer.

The micron fiber may be pretreated, prior to extrusion, to improve performance. According to one embodiment of the present invention, conductive or non-conductive powders are leached into the fibers prior to extrusion. In other embodiments, the fibers are subjected to any or several chemical modifications in order to improve the fibers interfacial properties. Fiber modification processes include, but are not limited to: chemically inert coupling agents; gas plasma treatment; anodizing; mercerization; peroxide treatment; benzoylation; or other chemical or polymer treatments.

Chemically inert coupling agents are materials that are molecularly bonded onto the surface of metal and or other fibers to provide surface coupling, mechanical interlocking, inter-difussion and adsorption and surface reaction for later bonding and wetting within the resin-based material. This chemically inert coupling agent does not react with the resin-based material. An exemplary chemically inert coupling agent is silane. In a silane treatment, silicon-based molecules from the silane bond to the surface of metal fibers to form a silicon layer. The silicon layer bonds well with the subsequently extruded resin-based material yet does not react with the resin-based material. As an additional feature during a silane treatment, oxane bonds with any water molecules on the fiber surface to thereby eliminate water from the fiber strands. Silane, amino, and silane-amino are three exemplary pre-extrusion treatments for forming chemically inert coupling agents on the fiber.

In a gas plasma treatment, the surfaces of the metal fibers are etched at atomic depths to re-engineer the surface. Cold temperature gas plasma sources, such as oxygen and ammonia, are useful for performing a surface etch prior to extrusion. In one embodiment of the present invention, gas plasma treatment is first performed to etch the surfaces of the fiber strands. A silane bath coating is then performed to form a chemically inert silicon-based film onto the fiber strands. In another embodiment, metal fiber is anodized to form a metal oxide over the fiber. The fiber modification processes described herein are useful for improving interfacial adhesion, improving wetting, and/or reducing oxide growth (when compared to non-treated fiber). Pretreatment fiber modification also reduces levels of particle dust, fines, and fiber release during subsequent cutting or vacuum line feeding.

In another embodiment, the resin-coated, micron conductive fiber wiring 40 of the present invention can be made resistant to corrosion and/or metal electrolysis by selecting micron conductive fiber and base resin that are resistant to corrosion and/or metal electrolysis. For example, if a corrosion/electrolysis resistant base resin is combined with micron stainless steel fiber, then a corrosion and/or metal electrolysis resistant resin-coated, micron conductive fiber wiring is achieved. Another additional and important feature of the present invention is that the resin-coated, micron conductive fiber wiring may be made flame retardant. Selection of a flame-retardant (FR) base resin material allows the resulting product to exhibit flame retardant capability. This is especially important in heating applications as described herein.

As an additional and important feature of the present invention, the resin-coated, micron conductive fiber wiring 40 exhibits excellent thermal conduction characteristics. Therefore, the resin-coated, micron conductive fiber wiring 40 can provide added thermal heating and/or dissipation capabilities to any application. For example, the resin-coated, micron conductive fiber wiring can be used for heating by passing an electrical current through the micron conductive fiber bundle 48. Alternatively, heat can be dissipated from another device, such as an electrical device, by physically and/or electrically connecting the resin-coated, micron conductive fiber wiring to that device.

As another important feature of the present invention, the resin-coated, micron conductive fiber wiring 40 can be easily interfaced to an electrical circuit or grounded. According to one embodiment, the micron conductive fiber 48 is made solderable. A solderable micron conductive fiber 48 comprises either a solderable metal fiber or a solderable metal plating onto the fiber. A soldered connection may be made between the resin-coated, micron conductive fiber wiring 40 and any circuit or connector by use of a melted solder connection via point, wave, or reflow soldering. In another embodiment, a solderable ink film is used to connect the micron conductive fiber bundle 18 to another conductive circuit or connector. One exemplary solderable ink is a combination of copper and solder particles in an epoxy resin binder. The resulting mixture is an active, screen-printable and dispensable material. During curing, the solder reflows to coat and to connect the copper particles and to thereby form a cured surface that is directly solderable without the need for additional plating or other processing steps. Any solderable material may then be mechanically and/or electrically attached, via soldering, to the resin-coated, micron conductive fiber wiring 40 at the location of the applied solderable ink. Many other types of solderable inks can be used to provide this solderable surface onto the resin-coated, micron conductive fiber wiring of the present invention. Another exemplary embodiment of a solderable ink is a mixture of one or more metal powder systems with a reactive organic medium. This type of ink material is converted to solderable pure metal during a low temperature cure without any organic binders or alloying elements.

In another embodiment, an electrical connection to the micron conductive fiber wiring may be achieved using a solderless crimp-on connector, as is known in the art. The solderless crimp-on connector pierces the outer resin-based layer to contact the inner micron conductive fiber. In yet another embodiment, the micron conductive fiber may be ultrasonically welded, or bonded, to a connector. In another embodiment, micron conductive fiber wiring that has been bonded to a connector may be encased in a heat shrink structure, as is known in the art, to provide electrical insulation and stress relief.

A ferromagnetic resin-coated, micron conductive fiber wiring 10 may be formed according to the present invention to create a magnetic or magnetizable form of the material. Ferromagnetic materials, such as ferrite materials and/or rare earth magnetic materials are used for the micron conductive fiber bundle 48. The ferromagnetic resin-coated, micron conductive fiber wiring 40 displays the excellent physical properties of the base resin, including flexibility, moldability, strength, and resistance to environmental corrosion, along with excellent magnetic ability. In addition, the unique ferromagnetic resin-coated, micron conductive fiber wiring 40 facilitates formation of items that exhibit excellent thermal and electrical conductivity as well as magnetism. The ferromagnetic resin-coated, micron conductive fiber wiring 40 may be magnetized by exposing the wiring to a strong magnetic field during or after the formation of the resin coating 45.

A ferromagnetic micron conductive fiber bundle 48 may be metal fiber or metal plated fiber. If metal plated fiber is used, then the core fiber is a platable material and may be metal or non-metal. Exemplary ferromagnetic conductive fiber materials include ferrite, or ceramic, materials as nickel zinc, manganese zinc, and combinations of iron, boron, and strontium, and the like. In addition, rare earth elements, such as neodymium and samarium, typified by neodymium-iron-boron, samarium-cobalt, and the like, are useful ferromagnetic conductive fiber materials. A ferromagnetic micron conductive fiber bundle 48 may further be a combination of a non-ferromagnetic micron conductive fiber and a ferromagnetic micron conductive fiber to form a resin-coated, micron conductive fiber wiring that combines excellent conductive qualities with magnetic capabilities.

The resin-coated, micron conductive fiber wiring 40 of the present invention combines excellent conductivity with low relative weight. A high strength and low weight wire 40 can be formed using, for example, a metal-plated glass micron fiber. While a round cross-sectional shape is shown, any shape of wire 40 can be produced. While the illustration shows only a relatively few number of fibers in the bundle 48, the overall bundle 18 actually comprises many individual fiber strands routed together. Thousands or tens of thousands of fibers are thus routed to form the bundle.

The micron conductive fiber bundle is a metal material in any form of, but not limited to, pure metal, combinations of metals, metal alloys, metals clad onto other metals, metals plated onto metal or non-metal cores, and the like. There are numerous metal materials that can be used to form the micron conductive fiber bundle according to the present invention. An exemplary list of micron conductive wire materials includes, but is not limited to:
(1) copper, alloys of copper such as coppered alloyed with any combination of beryllium, cobalt, zinc, lead, silicon, cadmium, nickel, iron, tin, chromium, phosphorous, and/or zirconium, and copper clad in another metal such as nickel;
(2) aluminum and alloys of aluminum such as aluminum alloyed with any combination of copper, magnesium, manganese, silicon, and/or chromium;
(3) nickel and alloys of nickel including nickel alloyed with any combination of aluminum, titanium, iron, manganese, and/or copper;
(4) precious metals and alloys of precious metals including gold, palladium, platinum, platinum, iridium, rhodium, and/or silver;
(5) glass ceiling alloys such as alloys of iron and nickel, iron and nickel alloy cores with copper cladding, and alloys of nickel, cobalt, and iron;
(6) refractory metals and alloys of refractory metals such as molybdenum, tantalum, titanium, and/or tungsten;
(7) resistive alloys comprising any combination of copper, manganese, nickel, iron, chromium, aluminum, and/or iron;
(8) specialized alloys comprising any of combination of nickel, iron, chromium, titanium, silicon, copper clad steel, zinc, and/or zirconium;
(9) spring wire formulations comprising alloys of any combination of cobalt, chromium, nickel, molybdenum, iron, niobium, tantalum, titanium, and/or manganese;
(10) stainless steel comprising alloys of iron and any combination of nickel, chromium, manganese, and/or silicon;
(11) thermocouple wire formulations comprising alloys of any combination of nickel, aluminum, manganese, chromium, copper, and/or iron.

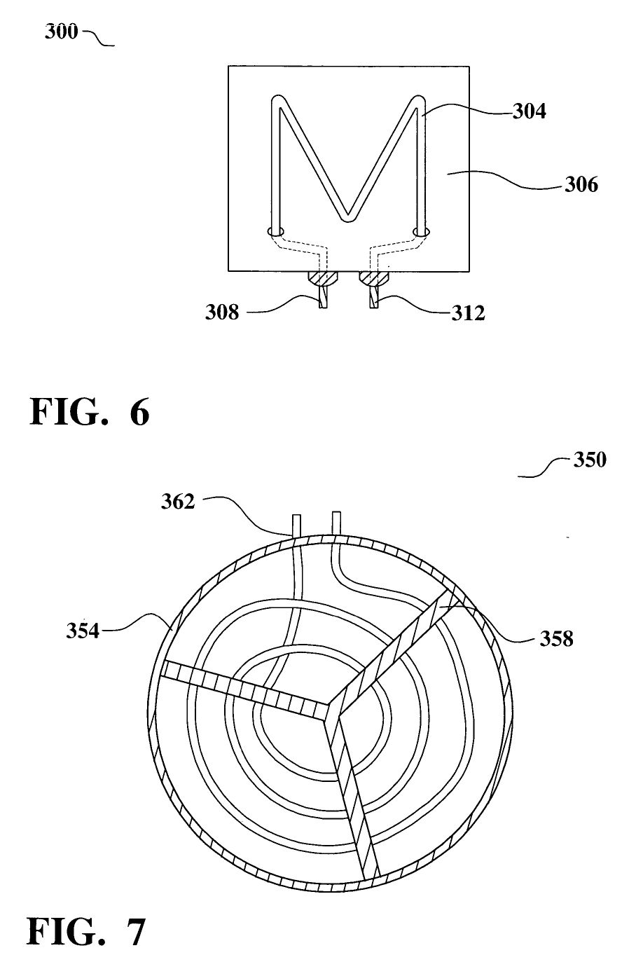

Referring now to FIG. 6, an embodiment of the present invention is illustrated. A heater 300 comprising the resin-coated, micron conductive fiber wiring 304 is shown. The resin-coated, micron conductive fiber wiring 304 is arranged over a substrate 306 such that a heating area is defined. Connectors 308 and 312 are physically attached to the bundle of micron conductive fibers of the wiring 304 by, for example, soldering. The micron conductive fiber is selected to create the needed resistance for the heating element 304. It is found that the present invention demonstrates a very rapid heating capability. The resin-based coating of the resin-coated, micron conductive fiber wiring 304 provides an electrical insulator to prevent electrical shock or shorting.

The resin-based coating of the wiring 304 is selected to have a glass transition temperature higher than the maximum operating temperature of the heating element. In this regard, in very high temperature applications, the resin-based coating material must comprise a base resin with very high temperature capability. Resins are typically divided into two major groups known as thermoplastic and thermoset. Thermoplastic resins become soft when heated, may be shaped or molded while in a heated semi fluid state, and become rigid when cooled. Thermoset resins, on the other hand, are usually liquids or low-melting-point solids in their initial form. When used, these thermosetting resins are “cured” by the use of a catalyst, heat, or a combination of the two, such the resin becomes a solid. Thermoset resins cannot be converted back to their original liquid form. Of particular importance to the present invention, thermoset resin compounds can exhibit very high maximum operating temperatures that are substantially higher than thermoplastic resins. Therefore, in the present invention, thermoplastic resins with very high maximum operating temperatures are preferably used as the coating material to form the heating element 304.

Referring now to FIG. 7, an embodiment of the present invention is illustrated. In this case, a stove-top heating device 350 is shown having a heating element 362 comprising the resin-coated, micron conductive fiber wiring of the present invention. The resin-coated, micron conductive fiber wiring 362 is held in a frame 358 and 354 that is capable of supporting a cooking pot. The micron conductive fiber of the wiring 362 is selected to create the needed resistance for the heating element 362. The resin-based coating of the wiring 362 is selected to have a glass transition temperature higher than the maximum operating temperature of the heating element. It is found that the present invention demonstrates a very rapid heating capability.

Referring now to FIG. 8, an embodiment of the present invention is illustrated. A medical cauterizing device 400 is shown. The cauterizing device 400 comprises a heating element 440 formed from the resin-coated, micron conductive fiber wiring. The wiring 440 is held in a handle 420 comprising an insulator material and, more preferably, comprising a resin-based material. A battery 430, or other power supply, and controlling circuit are included in the cauterizing device 400 handle 420. The resin-coated, micron conductive fiber wiring 440 forms a heating element with a very rapid heating characteristic. In one embodiment, the micron conductive fiber bundle in the wiring 440 is exposed at the cauterizing point 445. In another embodiment, the resin-based coating of the wiring 440 covers the micron conductive fiber bundle. The micron conductive fiber of the wiring 440 is selected to create the needed resistance for the heating element. The resin-based coating of the wiring 440 is selected to have a glass transition temperature higher than the maximum operating temperature of the heating element. Preferably a medical grade resin-based material and/or a medical grade conductive fiber material are chosen. It is found that the present invention demonstrates a very rapid heating capability.

Referring now to FIG. 9, an embodiment of the present invention is shown. An application 450 of the resin-coated, micron conductive fiber wiring 465 for conducting an electric current or signal is shown. The resin-coated, micron conductive fiber wiring 465 and 468 demonstrates excellent conductivity. Depending on the type of micron conductive fiber chosen, the resin-coated, micron conductive fiber wiring 465 and 468 demonstrates a conductivity on par with a similarly sized solid wire of copper while weighing much less. In addition, the small diameters of the micron conductive fiber provides a very low noise signal path that is especially well suited for applications such as speaker cables 465 and 468 as shown. In this embodiment, an audio source 455, such as a CD player, is connected to an audio amplifier 460. The audio amplifier 460 drives a set of audio speakers 470 and 474 through speaker cables comprising the resin-coated, micron conductive fiber wiring 465 and 468 of the present invention. In additional embodiments, the resin-coated, micron conductive fiber wiring is used for power cabling, for signal cabling of digital and/or analog signals, and the like.

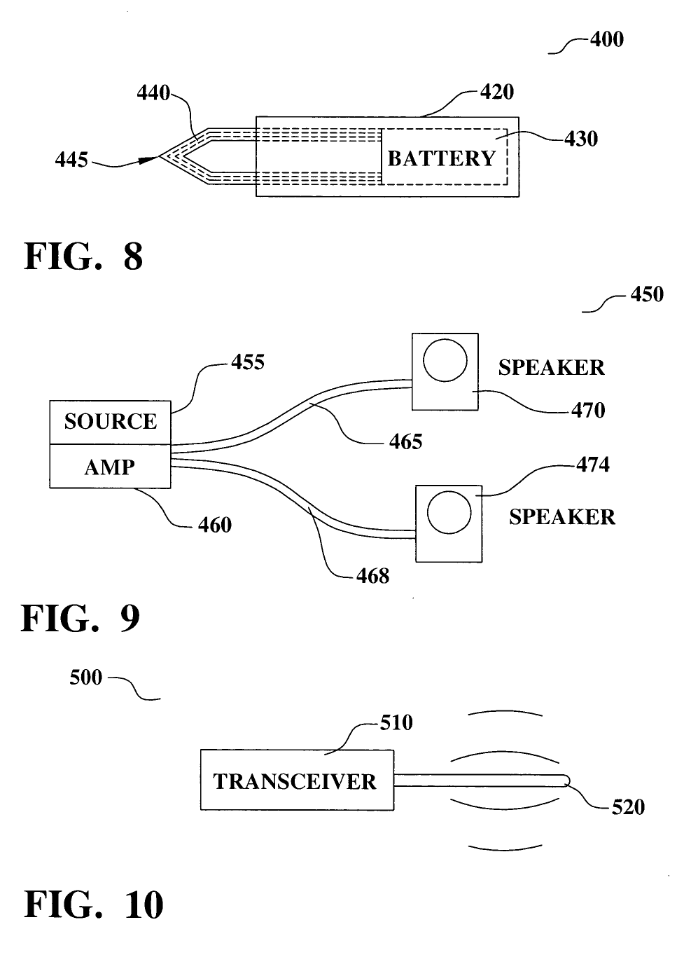

Referring now to FIG. 10, an embodiment 500 of the present invention is illustrated. An antenna 520 for a transceiver device 510 is formed from resin-coated, micron conductive fiber wiring 520 is shown. A transceiver device, such as a cellular or mobile telephone, a wireless computer, a walkie-talkie, or the like, requires an antenna structure to transmit and receive signals by electromagnetic energy. In addition, receiver devices, such as radios or televisions, or transmitting devices, such as beacons, require antenna structures. The resin-coated, micron conductive fiber wiring 520 of the present invention can be formed into the required antenna 520 shapes and/or sizes to create the desired resonance frequency characteristics. The resin-coated, micron conductive fiber wiring 520 demonstrates excellent absorption and/or transmission of RF energy. The low resistivity of the resin-coated, micron conductive fiber wiring 520 provides substantially excellent performance.

In the preferred embodiment illustrated, the resin-coated, micron conductive fiber wiring antenna 520 is a monopole shape. However, any number of shapes and antenna types can be formed of the wiring such as a spiral, a multi-loop, a serpentine pattern, or the like. These patterns are found to be particularly useful for detecting and converting magnetic field energy and/or to create an antenna with the desired wavelength. A wide variety of other antenna patterns may be used as dictated by the type of RF field, the strength of the RF field, the frequency of the RF field, and the desired size and shape of the completed transponder device. Monopole designs, dipole designs, PIFA's, inverted ‘F’ designs, planar designs, and the like, may be used. In addition, counterpoise structures and/or ground plane structures; not shown, may easily be formed of the resin-coated, micron conductive fiber wiring.

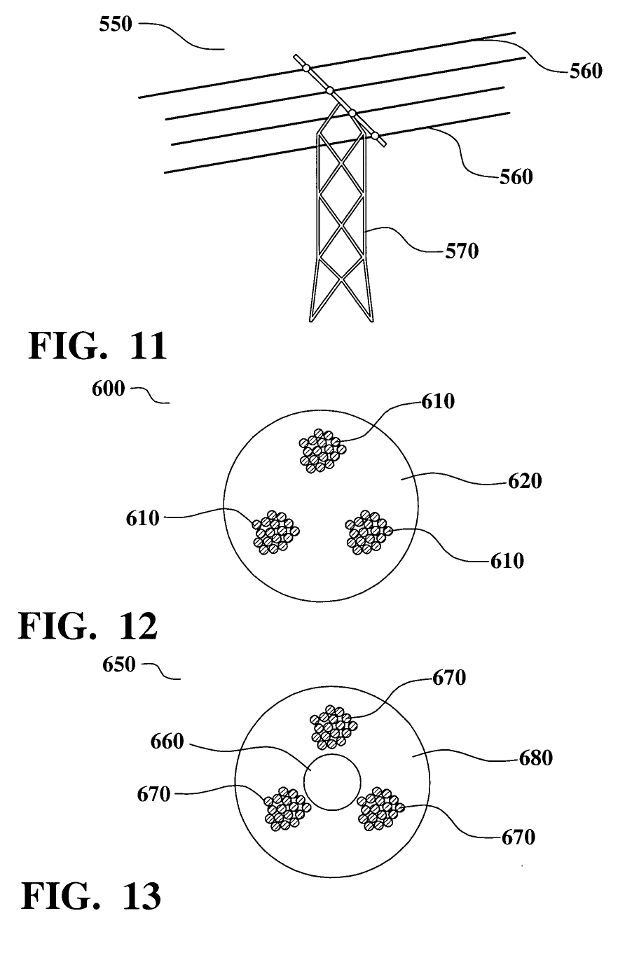

Referring now to FIG. 11, an embodiment 550 of the present invention is illustrated. The resin-coated, micron conductive fiber wiring 560 is applied to a high voltage power line system 550. In a high voltage power line system 550, large cables 560 are suspended high above the ground via towers 570. The electrical power is typically transmitted at a large voltage such that the current loading in the wiring 560 is reduced and the electrical loss due to I ²R is reduced. The resin-coated, micron conductive fiber wiring 560 presents several advantages in this application. First, the micron fiber is lower in weight than copper or aluminum cabling and yet is capable of low resistance. As a result, the weight loading on the towers 570 is reduced. In addition, the resin-coated, micron conductive fiber wiring 560 can be made substantially stronger by winding fiber bundles around a center core as is shown in FIG. 12 and is described below. For example, a center core of glass fiber or of steel can be used to provide additional strength to a resin-coated, micron conductive fiber wiring.

Referring now to FIG. 12, an embodiment of the present invention is illustrated. A multiple bundle, resin-coated, micron conductive fiber wiring 600 is shown. In this embodiment, multiple bundles 610 are pulled through the extrusion/pultrusion process at the same time. The bundles 610 may be in linear contact with each other or may be spaced apart. The bundles 610 may be simply routed in parallel or may be twisted together. A resin-based coating 620 surrounds the bundles 610.

Referring now to FIG. 13, an embodiment of the present invention is illustrated. A multiple bundle, resin-coated, micron conductive fiber wiring 650 with a center core 660 is shown. The center core 660 may be a conductive material, such as a steel cable or wire, or an insulator, such as glass fiber. The center core 660 is best applied as a means of strengthening the resin-coated, micron conductive fiber wiring 650 against breakage.

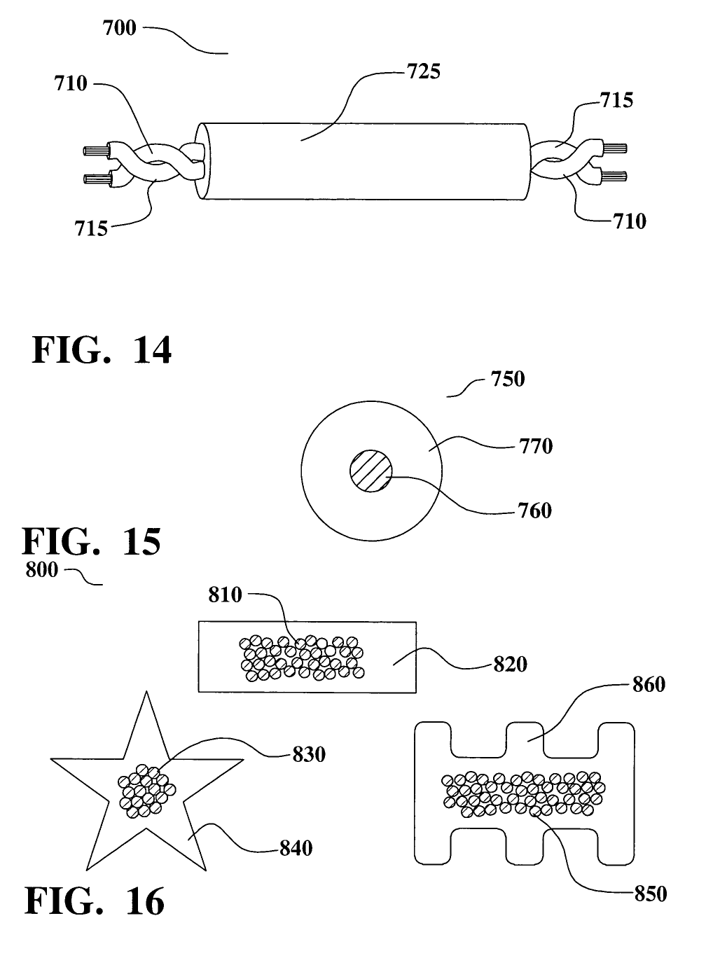

Referring now to FIG. 14, an embodiment of the present invention is illustrated. A twisted pair of resin-coated, micron conductive fiber wires 710 and 715 is shown. Each wire 710 and 715 comprises the resin-coated, micron conductive fiber wiring as described above. In this case, each wire 710 and 715 is formed separately as is described above. The completed wires 710 and 715 are then twisted together. As an additional embodiment, the twisted pair 710 and 715 is then coated with an additional resin-based coating 725 as a protection and to maintain the twisting arrangement.

Referring now to FIG. 15, an embodiment of the present invention is illustrated. A single strand, resin-coated, micron conductive fiber wire 750 is shown. As state above, any number of fibers can be used. The single strand 760 is coated with a resin-based coating 770 as described above. Alternatively, the coating 770 may be applied by spraying or dipping.

Referring now to FIG. 16, an embodiment 800 of the present invention is illustrated. Several alternative cross sectional shapes of resin-coated, micron conductive fiber wiring are shown. In one embodiment, a rectangular array 810 of fiber is surrounded with a resin-based coating 820 to make a rectangular cross section. In another embodiment, a star array 830 of fiber is surrounded with a resin-based coating 840 to form a star cross section. In another embodiment, a corrugated cross section of resin-based coating 860 is formed around an array 850 of fiber.

While the invention has been particularly shown and described with reference to the preferred embodiments thereof, it will be understood by those skilled in the art that various changes in form and details may be made without departing from the spirit and scope of the invention.

What is claimed is:

1. A heating element device comprising:
a bundle of micron conductive fiber strands each fiber strand having a diameter of less than 20 microns; and
a resin-based coating extruded around the micron conductive fibers.

2. The device according to claim 1 wherein the micron conductive fiber strands are metal.

3. The device according to claim 1 wherein the micron conductive fiber strands are metal plated.

4. The device according to claim 1 wherein the micron conductive fiber strands comprise non-conductive material that is metal plated.

5. The device according to claim 1 wherein the micron conductive fiber strands are nickel plated carbon micron fiber, stainless steel micron fiber, copper micron fiber, silver micron fiber or combinations thereof.

6. The device according to claim 1 further comprising a second bundle of micron conductive fiber strands onto which are extruded the resin-based material.

7. The device according to claim 6 wherein the bundles of micron conductive fiber strands are twisted to make a twisted pair.

8. The device according to claim 7 further comprising a center core onto which the bundles of micron conductive fiber strands are twisted.

9. The device according to claim 1 further comprising a chemically inert coupling agent overlying the micron conductive fiber strands.

10. The device according to claim 1 wherein the micron conductive fiber strands are ferromagnetic material.

11. A heating device comprising:
an electrical power source; and
a heating element operatively coupled across the electrical power source comprising:
a bundle of micron conductive fiber strands each fiber strand having a diameter of less than 20 microns; and
a resin-based coating extruded around the micron conductive fibers.

12. The device according to claim 11 wherein the micron conductive fiber strands are metal.

13. The device according to claim 11 wherein the micron conductive fiber strands are metal plated.

14. The device according to claim 11 wherein the micron conductive fiber strands comprise non-conductive material that is metal plated.

15. The device according to claim 11 wherein the micron conductive fiber strands are nickel plated carbon micron fiber, stainless steel micron fiber, copper micron fiber, silver micron fiber or combinations thereof.

16. The device according to claim 11 further comprising a second bundle of micron conductive fiber strands onto which are extruded the resin-based material.

17. The device according to claim 16 wherein the bundles of micron conductive fiber strands are twisted to make a twisted pair.

18. The device according to claim 17 further comprising a center core onto which the bundles of micron conductive fiber strands are twisted.

19. The device according to claim 11 further comprising a chemically inert coupling agent overlying the micron conductive fiber strands.

20. The device according to claim 11 further comprising an anodizing coating overlying the micron conductive fiber strands.

21. A method to form heating element devices comprising:
extruding/pultruding a resin-based material onto a bundle of micron conductive fiber strands each fiber strand having a diameter of less than 20 microns; and
sectioning the extruded/pultruded bundle into finite heating element devices.

22. The method according to claim 21 further comprising compressing the bundle of micron conductive fiber strands prior to extruding/pultruding.

23. The method according to claim 22 wherein said step of compressing comprises pulling said bundle through a compression ring.

23. The method according to claim 21 wherein said step of extruding/pultruding comprises pulling said bundle through a crosshead die.

24. The method according to claim 21 further comprising pre-treating said bundle prior to said step of compressing.

25. The method according to claim 24 wherein said step of pre-treating comprises leeching micron conductive powder into said bundle.

26. The method according to claim 24 wherein said step of pre-treating comprises forming a chemically inert coupling agent onto said micron conductive fiber strands.

27. The method according to claim 24 wherein said step of pre-treating comprises anodizing said micron conductive fiber.

28. The method according to claim 24 wherein said step of pre-treating comprises exposing said micron conductive fiber strands to gas plasma.

29. The method according to claim 21 wherein said step of extruding/pultruding further comprises adding a micron conductive material to the resin-based material and extruding/pultruding the combination of said resin-based material and the micron conductive material onto the bundle.

30. The method according to claim 21 further comprising a second bundle of micron conductive fiber strands onto which are extruded the resin-based material.
